(19) United States
(12) Patent Application Publication
(10) Pub. No.: US 2024/0101773 A1
(43) Pub. Date: Mar. 28, 2024

(54) MANUFACTURING METHOD OF PROTON CONDUCTING MEMBRANE

(71) Applicant: DENSO CORPORATION, Kariya-city (JP)

(72) Inventors: Kazuki TAKAHASHI, Kariya-city (JP); Yoshifumi ISOZAKI, Kariya-city (JP)

(21) Appl. No.: 18/519,561

(22) Filed: Nov. 27, 2023

Related U.S. Application Data
(63) Continuation of application No. PCT/JP2022/023574, filed on Jun. 13, 2022.

(30) Foreign Application Priority Data
Jun. 22, 2021 (JP) 2021-103216

(51) Int. Cl. C08J 5/22

(52) U.S. Cl. CPC C08J 5/2287; C08J 5/2256; C08J 2327/18; C08J 2379/08

(57) ABSTRACT

A manufacturing method of a proton conducting membrane includes a pressing process, a hydrolyzing process, and a peeling process. In the pressing process, a resin film is brought into contact with at least one surface of an electrolyte resin material dissolved in polyphosphoric acid and pressure is applied to form the electrolyte resin material into a membrane shape. In the hydrolyzing process, the polyphosphoric acid is hydrolyzed and phosphorylated after the pressing process. In the peeling process, the resin film is peeled off from the electrolyte resin material having the membrane shape after the hydrolyzing process to obtain the proton conducting membrane made of the electrolyte resin material containing phosphoric acid. The resin film is made of a resin having an acidic substituent.

### CROSS REFERENCE TO RELATED APPLICATIONS

The present application is a continuation application of International Patent Application No. PCT/JP2022/023574 filed on Jun. 13, 2022, which designated the U.S. and claims the benefit of priority from Japanese Patent Application No. 2021-103216 filed on Jun. 22, 2021. The entire disclosures of all of the above applications are incorporated herein by reference.

### TECHNICAL FIELD

The present disclosure relates to a manufacturing method of a proton conducting membrane.

### BACKGROUND

A non-humidified medium-temperature operated fuel cell that operates at a temperature of 100° C. or higher and under a condition of no humidification is desired from the viewpoint of cost reduction and system simplification of a solid polymer fuel cell system. In order to operate the fuel cell without humidification, a proton conducting membrane plays an important role.

### SUMMARY

The present disclosure provides a manufacturing method of a proton conducting membrane including a pressing process, a hydrolyzing process, and a peeling process. In the pressing process, a resin film is brought into contact with at least one surface of an electrolyte resin material dissolved in polyphosphoric acid and pressure is applied to form the electrolyte resin material into a membrane shape. In the hydrolyzing process, the polyphosphoric acid is hydrolyzed and phosphorylated after the pressing process. In the peeling process, the resin film is peeled off from the electrolyte resin material having the membrane shape after the hydrolyzing process to obtain the proton conducting membrane made of the electrolyte resin material containing phosphoric acid. The resin film is made of a resin having an acidic substituent.

### BRIEF DESCRIPTION OF DRAWINGS

Objects, features and advantages of the present disclosure will become apparent from the following detailed description made with reference to the accompanying drawings. In the drawings:

FIG. 1 is a conceptual diagram of a fuel cell according to an embodiment of the present disclosure;

FIG. 2A is a diagram illustrating a material supply process in a press forming;

FIG. 2B is a diagram illustrating a pressing process in the press forming;

FIG. 2C is a diagram illustrating a hydrolyzing process in the press forming;

FIG. 2D is a diagram illustrating a peeling process in the press forming;

FIG. 3 is a diagram showing phosphorylation of polyphosphoric acid in the hydrolyzing process;

FIG. 4A is a diagram illustrating a material supply process and a pressing process in a roller forming;

FIG. 4B is a diagram illustrating a hydrolyzing process in the roller forming;

FIG. 4C is a diagram illustrating a peeling process in the roller forming;

FIG. 5 is a diagram showing electrolyte resin materials, materials of protective sheets, and forming methods of Examples and Comparative Examples; and

FIG. 6 is a diagram showing various measured values of Examples and Comparative Examples.

### DETAILED DESCRIPTION

Next, a relevant technology is described only for understanding the following embodiments. A proton conducting membrane of a non-humidified medium-temperature operated fuel cell may be a polymer membrane in which polybenzimidazole (PBI) is doped with phosphoric acid, which is a proton carrier. A membrane resistance of a phosphoric acid-doped polymer membrane is inversely proportional to the amount of doped phosphoric acid, and the membrane resistance can be reduced with increase in the amount of doped phosphoric acid.

The phosphoric acid-doped polymer membrane can be obtained, for example, by a PPA process in which an electrolyte resin material is dissolved in polyphosphoric acid to form a thin membrane and the obtained polymer membrane is exposed to air at an appropriate humidity to hydrolyze and phosphorylate the polyphosphoric acid with moisture in air. It is generally known that in the PPA process, more phosphoric acid can be doped than in a method in which a polymer membrane is immersed in phosphoric acid to obtain a phosphoric acid-doped polymer membrane, and therefore the membrane resistance can be reduced.

Polyphosphoric acid used in the PPA process has high tackiness. Therefore, in a manufacturing method in which an electrolyte resin material dissolved in polyphosphoric acid is applied with pressure, a polymer membrane adheres to a protective sheet, a jig, or the like used for a pressure forming and it is difficult to peel off the polymer membrane. Thus, it is difficult to prepare a thin membrane having high flatness and high denseness. As a result, in the manufacturing method in which the electrolyte resin material dissolved in the polyphosphoric acid is applied with pressure, the quality of the proton conducting membrane may be degraded, and the quality of a fuel cell may be degraded.

Since polyphosphoric acid loses its adhesiveness when it is hydrolyzed, polyphosphoric acid is easily hydrolyzed in a manufacturing method in which one surface of a polymer membrane can be brought into contact with the atmosphere, such as a drop casting method, a blade coating method, or a spin coating method, and the polymer membrane can be easily peeled off from a protective sheet or the like. However, since these manufacturing methods have poor productivities, it is difficult to increase the area of the polymer membrane or to mass-produce the polymer membrane.

A manufacturing method of a proton conducting membrane according to an aspect of the present disclosure includes a pressing process, a hydrolyzing process, and a peeling process. In the pressing process, a resin film is brought into contact with at least one surface of an electrolyte resin material dissolved in polyphosphoric acid and pressure is applied to form the electrolyte resin material into a membrane shape. In the hydrolyzing process, the polyphosphoric acid is hydrolyzed and phosphorylated after the pressing process. In the peeling process, the resin film is peeled off from the electrolyte resin material having the membrane shape after the hydrolyzing process to obtain the proton conducting membrane made of the electrolyte resin material containing phosphoric acid. The resin film is made of a resin having an acidic substituent.

In the above-described manufacturing method, the resin film having the acidic substituent is used as the resin film that is brought into contact with the electrolyte resin material when the electrolyte resin material dissolved in polyphosphoric acid is formed into a thin membrane by a pressure forming. Therefore, moisture in air can reach the electrolyte resin material through the resin film, the hydrolysis of the polyphosphoric acid can be promoted and the polyphosphoric acid can be phosphorylated, and the resin film can be easily peeled off from the proton conducting membrane. Accordingly, even when the proton conducting membrane is manufactured from the electrolyte resin material dissolved in the polyphosphoric acid by the pressure forming, the proton conducting membrane having high flatness and high denseness can be obtained, and the proton conducting membrane having high quality can be obtained.

Hereinafter, embodiments of the present disclosure will be described with reference to the drawings.

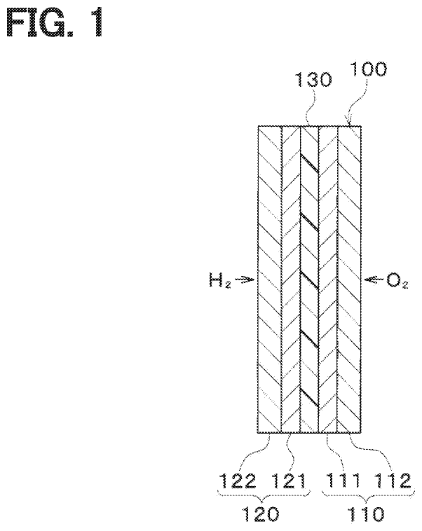

As shown in FIG. 1, a fuel cell 100 includes a cathode electrode 110, an anode electrode 120, and an electrolyte membrane 130. The cathode electrode 110 is also referred to as an air electrode, and the anode electrode 120 is also referred to as a hydrogen electrode.

The fuel cell 100 outputs an electric energy using an electrochemical reaction between a fuel gas (hydrogen) and an oxidant gas (oxygen in air). The fuel cell 100 is provided as a basic unit, and multiple fuel cells 100 are stacked as a stacked structure to be used.

When the fuel cell 100 is supplied with a reaction gas such as hydrogen and air, hydrogen and oxygen electrochemically react with each other to output electric energy as described below.

(Anode Electrode Side) H₂→2H⁺+2e⁻

(Cathode Electrode Side) 2H⁺+1/2O₂+2e⁻→H₂O

In this case, in the anode electrode 120, hydrogen is ionized into electron (e⁻) and proton (H⁺) by a catalytic reaction, and the proton (H⁺) moves through the electrolyte membrane 130. On the other hand, in the cathode electrode 110, protons (H⁺) migrating from the anode electrode 120, electrons flowing from the outside, and oxygen (O₂) in air react with each other to generate water.

The fuel cell 100 of the present embodiment generates electric power at a temperature of 100° C. or higher without humidifying the electrolyte membrane 130. That is, during operation of the fuel cell 100, dry air is supplied to the cathode electrode 110.

The cathode electrode 110 includes a cathode catalyst layer 111 and a cathode diffusion layer 112. The cathode catalyst layer 111 is disposed in close contact with a surface of the electrolyte membrane 130 that is close to the air electrode. The cathode diffusion layer 112 is disposed on an outer side of the cathode catalyst layer 111.

The anode electrode 120 includes an anode catalyst layer 121 and an anode diffusion layer 122. The anode catalyst layer 121 is disposed in close contact with a surface of the electrolyte membrane 130 that is close to the hydrogen electrode. The anode diffusion layer 122 is disposed on an outer side of the anode catalyst layer 121.

Each of the catalyst layers 111 and 121 is formed of, for example, a carbon-supported platinum catalyst in which a catalyst such as platinum for promoting an electrochemical reaction is supported on a carbon support, and each of the diffusion layers 112 and 122 is formed of, for example, carbon cloth.

The electrolyte membrane 130 is a proton conducting membrane. In the present embodiment, a polymer membrane doped with phosphoric acid is used as the proton conducting membrane. Phosphoric acid is a proton conducting substance. The polymer membrane doped with phosphoric acid is also referred to as a phosphoric acid-doped polymer membrane.

In the present embodiment, a polyphosphoric acid solution of an electrolyte resin material is thinned by pressure forming, and polyphosphoric acid contained in the obtained polymer membrane is hydrolyzed and phosphorylated to obtain the proton conducting membrane which is the phosphoric acid-doped polymer membrane.

In the present embodiment, the thickness of the proton conducting membrane is 150 μm or less. When the thickness of the proton conducting membrane is 150 μm or less, the membrane resistance can be lowered and the proton conductivity can be improved. In the present embodiment, the thickness of the proton conducting membrane is 1 μm or more. When the thickness of the proton conducting membrane is 1 μm or more, the strength of the proton conducting membrane can be secured.

In the present embodiment, the concentration of the electrolyte resin material in the polyphosphoric acid solution is set within a range of 1 wt % to 20 wt %. When the concentration of the electrolyte resin material is lower than 1 wt %, thinning becomes difficult. When the concentration of the electrolyte resin material is higher than 20 wt %, it is difficult to obtain a high-quality polymer membrane when thinning is performed.

The electrolyte resin material constituting the proton conducting membrane is preferably a polymer that easily retains phosphoric acid. As the polymer that easily retains phosphoric acid, a basic resin material having N or NH in a main chain or a side chain, or a resin material having at least one acidic substituent selected from a group consisting of a sulfo group (—SO₃H), a carboxyl group (—COOH), a hydroxy group (—OH), a phosphonic group (—PO(OH)₂), and derivatives thereof in at least one of a main chain or a side chain can be used. The derivative means one in which a part of the chemical structure is replaced by another atom or atomic group.

As the electrolyte resin material constituting the proton conducting membrane, at least one e selected from a group consisting of polybenzimidazole, sulfonated polyimide, perfluorosulfonic acid polymer, and derivatives thereof can be used.

As the electrolyte resin material constituting the proton conducting membrane, QAPOH doped with phosphoric acid (PA-doped QAPOH) or PWN70 described below can be used.

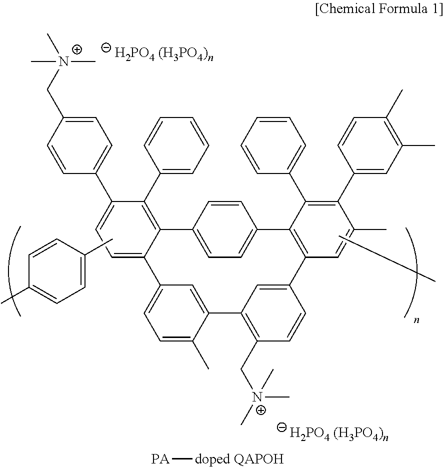

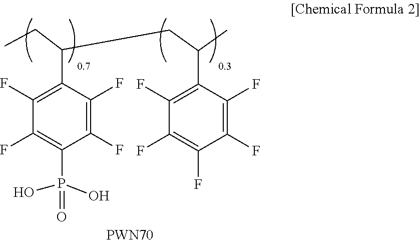

The QAPOH doped with phosphoric acid (PA-doped QAPOH) is disclosed in Kwan-Soo Lee et. al, “An operationally flexible fuel cell based on quaternary ammonium-biphosphate ion pairs”, Nature Energy, 2016. The PWN70 is disclosed in V. Atanasov et. al, “Synergistically integrated phosphonated poly(pentafluorostyrene) for fuel cells”, Nature Materials, March 2021.

Next, a manufacturing method of the proton conducting membrane of the present embodiment will be described. As described above, in the present embodiment, the thickness of the proton conducting membrane is reduced by pressure forming of the electrolyte resin material dissolved in polyphosphoric acid. As the pressure forming, for example, a press forming and a roller forming can be used.

The manufacturing method of the proton conducting membrane of the present embodiment includes at least a pressing process, a hydrolyzing process, and a peeling process. These processes are performed in the order of the pressing process, the hydrolysis process, and the peeling process.

In the pressing process, pressing and extending are performed in a state where the electrolyte resin material dissolved in polyphosphoric acid is brought into contact with two protective sheets from both sides to obtain a polymer membrane. In the hydrolyzing process, polyphosphoric acid contained in the polymer membrane is hydrolyzed and phosphorylated. In the peeling process, the protective sheets are peeled off from the polymer membrane. Through the above processes, the proton conducting membrane made of a phosphate-doped polymer membrane can be obtained.

The protective sheets are interposed between the electrolyte resin material dissolved in the polyphosphoric acid and a pressing device, and serves as bases when extending the electrolyte resin material while applying pressure. In the present embodiment, resin films having acidic substituents are used as the protective sheets. The resin films having acidic substituents are also referred to as acidic resin films. The acidic resin films easily absorb moisture in air, and moisture easily permeates the acidic resin films.

As the resin material constituting the acidic resin films, a resin material having at least one acidic substituent selected from a group consisting of a sulfo group (—SO₃H), a carboxyl group (—COOH), a hydroxy group (—OH), a phosphonic group (—PO (OH)₂), and derivatives thereof in at least one of a main chain or a side chain can be used. As the acidic resin film, for example, Nafion (registered trademark of DuPont), which is a perfluorosulfonic acid polymer, poly(vinyl phosphonic acid), polystyrene sulfite, or the like can be used.

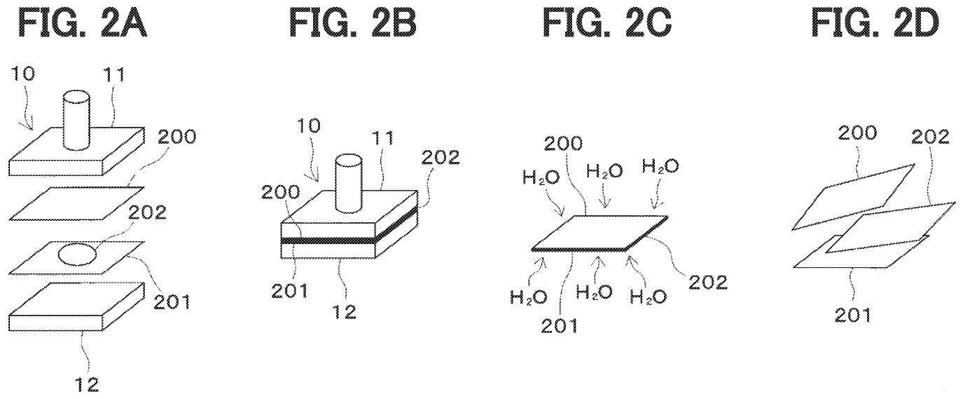

Here, a manufacturing method of the proton conducting membrane by a press forming will be described with reference to FIGS. 2A to 2D. As shown in FIG. 2A, a press forming apparatus 10 includes an upper press plate 11 and a lower press plate 12. The press forming apparatus 10 is a uniaxial press machine in which pressure is applied by the upper press plate 11. In the press forming, two protective sheets 200 and 201 are used.

In a material supply process shown in FIG. 2A, an electrolyte resin material 202 dissolved in polyphosphoric acid is supplied between the first protective sheet 200 and the second protective sheet 201. The electrolyte resin material 202 is a polyphosphoric acid solution and is a high viscosity liquid. The electrolyte resin material 202 is sandwiched between the first protective sheet 200 and the second protective sheet 201.

In a pressing process shown in FIG. 2B, the first protective sheet 200 and the second protective sheet 201 are pressed from the outside by the upper press plate 11 and the lower press plate 12. Accordingly, the electrolyte resin material 202 sandwiched between the first protective sheet 200 and the second protective sheet 201 is extended by applying pressure into a thin membrane shape.

In the pressing process, it is desirable that the electrolyte resin material 202 is maintained in a state of a high viscosity liquid for thinning, and it is desirable that hydrolysis of polyphosphoric acid contained in the electrolyte resin material 202 does not proceed. Therefore, in the pressing process, the environmental humidity is set to be lower than that in a hydrolyzing process. The environmental humidity is the humidity around the electrolyte resin material 202. Specifically, in the pressing process, it is desirable that the environmental humidity is less than 15% relative humidity. The environmental humidity may be adjusted using a humidity adjustment device (not shown). The humidity adjustment device is a device capable of performing humidification and dehumidification.

In the hydrolyzing process shown in FIG. 2C, the electrolyte resin material 202 sandwiched between the two protective sheets 200 and 201 is removed from the upper press plate 11 and the lower press plate 12, and is exposed to air having a predetermined humidity for a predetermined time. In the hydrolyzing process, the electrolyte resin material 202 sandwiched between the two protective sheets 200 and 201 may be left for several minutes.

In the hydrolyzing process, in order to promote hydrolysis of the polyphosphoric acid contained in the electrolyte resin material 202, it is desirable that the environmental humidity is as high as possible. In the hydrolyzing process, the environmental humidity is made higher than that in the pressing process. The environmental humidity in the hydrolyzing process is preferably 15% or more relative humidity.

In the present embodiment, the acidic resin films are used as the protective sheets 200 and 201. Therefore, in the hydrolyzing process, moisture in air passes through the protective sheets 200 and 201 and is supplied to the electrolyte resin material 202.

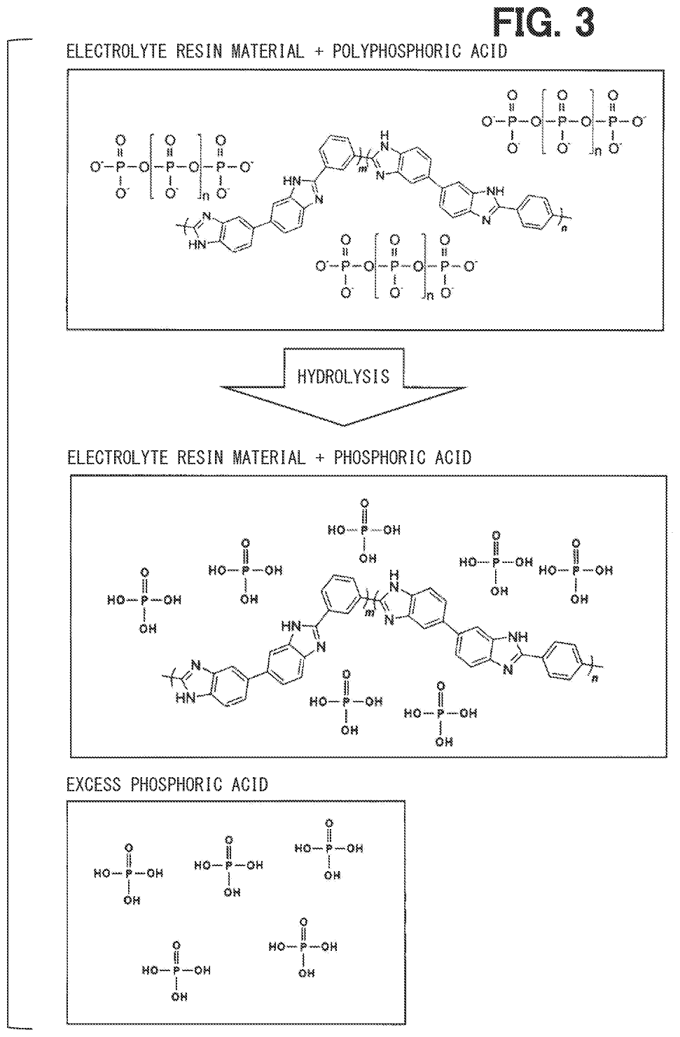

As shown in FIG. 3, in the hydrolyzing process, polyphosphoric acid contained in the electrolyte resin material 202 is hydrolyzed and phosphorylated.

In a peeling process shown in FIG. 2D, the first protective sheet 200 and the second protective sheet 201 are peeled from the electrolyte resin material 202 having the membrane shape. The electrolyte resin material 202 loses adhesiveness due to hydrolysis of polyphosphoric acid, and the protective sheets 200 and 201 can be easily peeled off. Accordingly, it is possible to obtain a proton conducting membrane made of the electrolyte resin material 202 in the form of a membrane containing phosphoric acid. Excess phosphoric acid and water attached to the proton conducting membrane are wiped off.

The protective sheets 200 and 201 peeled off in the peeling process can be directly returned to the material supplying process and the pressing process, which are preceding processes, and reused for the production of the next proton conducting membrane. That is, the protective sheets 200 and 201 can be repeatedly used.

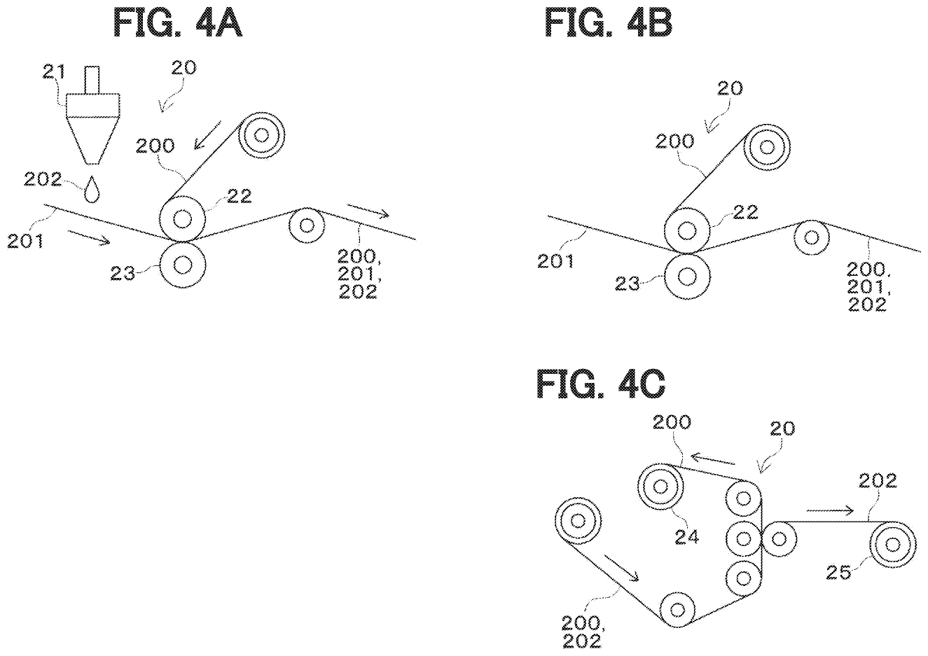

Next, a manufacturing method of the proton conducting membrane by a roller forming will be described with reference to FIGS. 4A to 4C.

As shown in FIG. 4A, a roller forming apparatus 20 includes an extruder 21, pressure rollers 22 and 23, and winding rollers 24 and 25.

In a material supply process and a pressing process shown in FIG. 4A, the electrolyte resin material 202 dissolved in polyphosphoric acid is supplied from the extruder 21 between the first protective sheet 200 and the second protective sheet 201. Subsequently, the first protective sheet 200 and the second protective sheet 201 are pressed from the outside by the upper pressure roller 22 and the lower pressure roller 23. Accordingly, the electrolyte resin material 202 is rolled into a thin membrane.

In a hydrolyzing process shown in FIG. 4B, the electrolyte resin material 202 sandwiched between the two protective sheets 200 and 201 is exposed to air having a predetermined humidity fora predetermined time. In the hydrolyzing process, the pressure rollers 22 and 23 and the winding rollers 24 and 25 are stopped, and the electrolyte resin material 202 sandwiched between the protective sheets 200 and 201 may is left for several minutes.

Also in the roller forming, in the pressing process, the environmental humidity is lowered in order to restrict the hydrolysis of the polyphosphoric acid contained in the electrolyte resin material 202, and in the hydrolyzing process, the environmental humidity is made higher than that in the pressing process in order to promote the hydrolysis of the polyphosphoric acid. The environmental humidity in the pressing process is preferably less than 15% relative humidity, and the environmental humidity in the hydrolyzing process is preferably 15% or more relative humidity.

In the hydrolyzing process, moisture in air passes through the protective sheets 200 and 201 and is supplied to the electrolyte resin material 202. Accordingly, the polyphosphoric acid contained in the electrolyte resin material 202 is hydrolyzed and phosphorylated.

In the peeling process, the first protective sheet 200 and the second protective sheet 201 are peeled from the electrolyte resin material 202 having the membrane shape. FIG. 4C shows a part of a peeling process in which the second protective sheet 201 has already been peeled off from the electrolyte resin material 202, and the first protective sheet 200 is being peeled off from the electrolyte resin material 202. The upper protective sheet 200 is wound around the first winding roller 24, and the electrolyte resin material 202 having a membrane shape is wound around the second winding roller 25. The electrolyte resin material 202 loses adhesiveness due to hydrolysis of polyphosphoric acid, and the protective sheets 200 and 201 can be easily peeled off.

Accordingly, it is possible to obtain a proton conducting membrane made of the electrolyte resin material 202 in the form of a membrane containing phosphoric acid. Excess phosphoric acid and water attached to the proton conducting membrane made of the electrolyte resin material 202 are wiped off.

Also in the roller forming, the protective sheets 200 and 201 peeled off in the peeling process can be returned to the material supply process and the pressing process, which are preceding processes, and reused for the t production of the next proton conducting membrane.

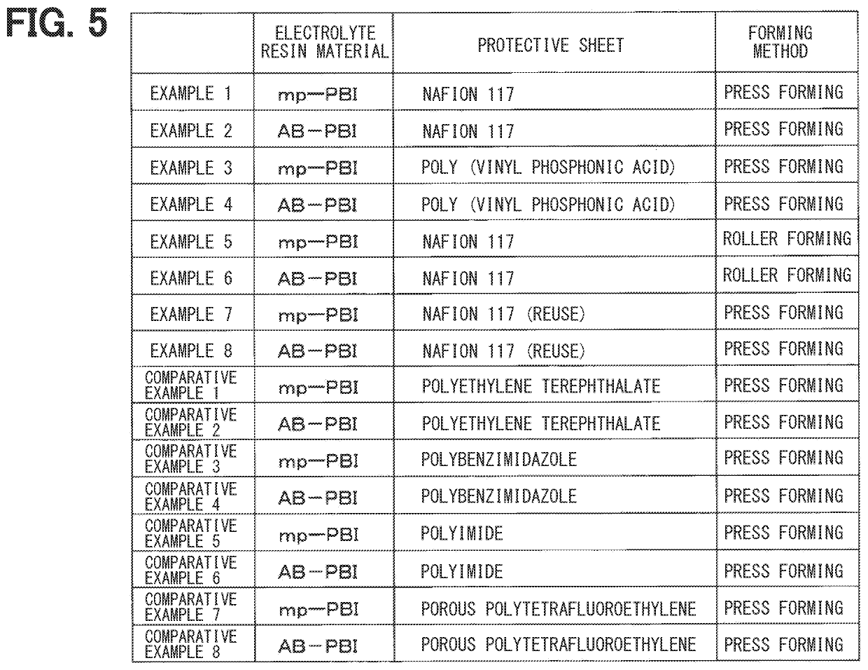

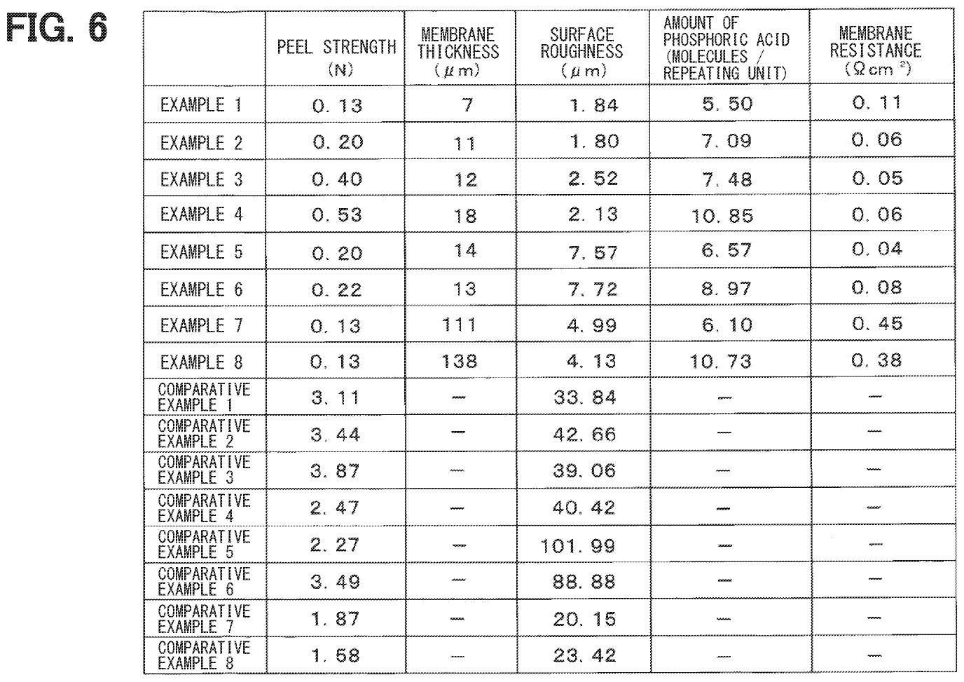

Next, Examples 1 to 8 and Comparative Examples 1 to 8 will be described with reference to FIG. 5 and FIG. 6. As shown in FIG. 5, Examples 1 to 8 and Comparative Examples 1 to 8 are different in the electrolyte resin material, the material of the protective sheet, and the forming process.

In Examples 1, 3, 5, and 7 and Comparative Examples 1, 3, 5, and 7, mp-polybenzimidazole (mp-PBI) shown below was used as the electrolyte resin material. The mp-PBI is disclosed in Andrew T. et. al, “Durable High Polymer Content m/p-Polybenzimidazole Membranes for Extended Lifetime Electrochemical Devices”, Applied Energy Materials, 2019, 2, 1720-1726.

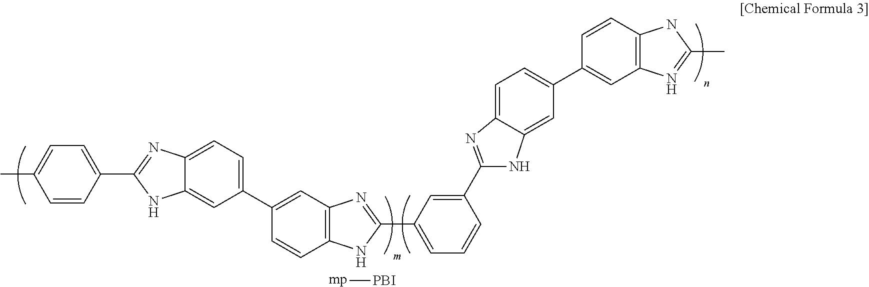

In Examples 2, 4, 6, and 8 and Comparative Examples 2, 4, 6, and 8, AB-polybenzimidazole (AB-PBI) shown below was used as the electrolyte resin material. The AB-PBI is disclosed in Alexander L. et. al, “A New Sequence Isomer of AB-Polybenzimidazole for High-Temperature PEM Fuel Cells”, J. Polym. Sci., A, Chem. 2012, 50, 306-313.

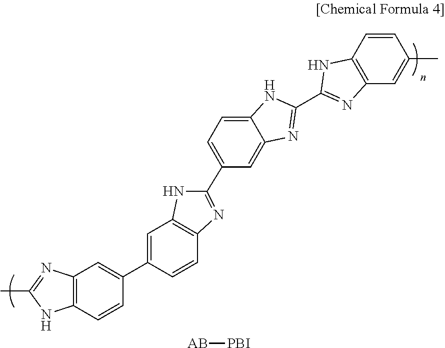

Here, a method for synthesizing a polyphosphoric acid solution of mp-PBI will be described.

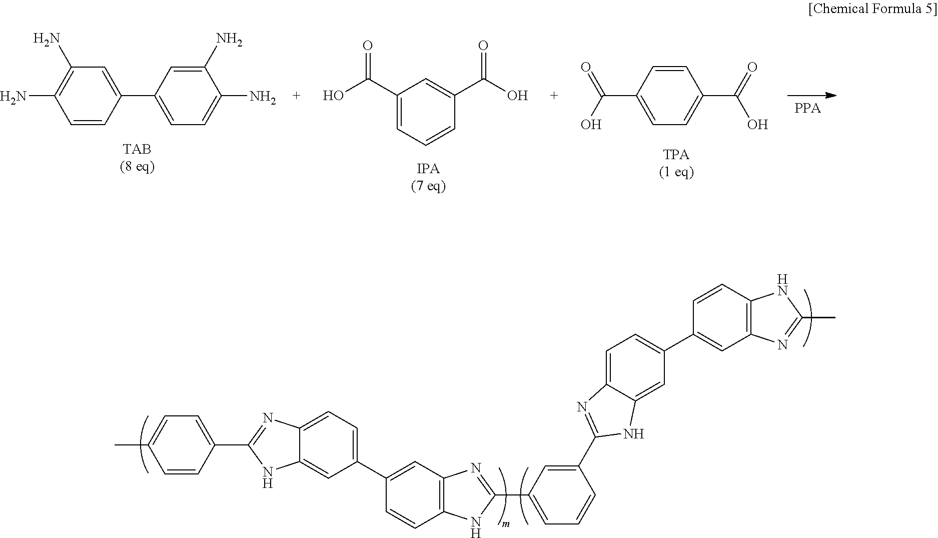

Into a 500 ml separable flask, 36.4 grams (170.00 mmol) of 3,3′-diaminobenzidine, 24.7 grams (148.75 mmol) of isophthalic acid, 3.5 grams (21.25 mmol) of terephthalic acid, and 595 grams of polyphosphoric acid were added in this order. The separable flask containing these materials was immersed in an oil bath preheated to 60° C., and stirred with a mechanical stirrer equipped with a magnetic coupling type stirring seal under an argon gas flow.

The separable flask containing the above-described materials was heated and stirred under a predetermined temperature raising condition, and finally stirred at 195° C. for 12 hours. The temperature of the heating and stirring was raised from 60° C. by 20° C. every 15 minutes, maintained at 140° C. for 2 hours, then raised by 55° C. every 30 minutes, and maintained at 195° C. for 12 hours. After reaching 195° C., stirring became impossible in 2 hours, but the reaction was continued. After completion of the heating and stirring, the reaction mixture was cooled to 100° C. (bath temperature), and 601.1 g of a polyphosphoric acid solution of mp-PBI was obtained.

Next, a method for synthesizing a polyphosphoric acid solution of AB-PBI will be described. First, a method for synthesizing 2,2′-bisbenzimidazole-5,5′-dicarboxylic acid (BBDCA) as an intermediate will be described.

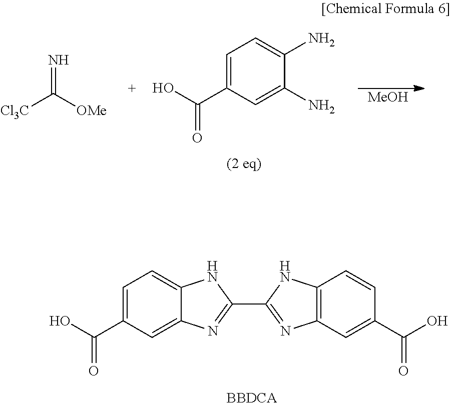

65.6 grams (431.15 mmol) of 3,4-diaminobenzoic acid and 1640 ml of methanol (dehydrated) were added into a 3 L four-neck flask under an argon gas flow, and the mixture was cooled on ice. Subsequently, 38 grams (215.58 mmol) of methyl 2,2,2-trichloroacetimidate was added dropwise into the four-neck flask. After dropwise addition, the mixture was heated to 50° C. (internal temperature) and stirred for 24 hours.

After the reaction solution was allowed to cool, a crystallized product was subjected to solid-liquid separation by centrifugation. The centrifugation was performed at a temperature of 10° C. and a rotation speed of 3,100 rpm for 15 minutes.

The solid was washed three times with methanol and one time with ethanol, and then dried under reduced pressure at 100° C. overnight to obtain 37.2 g of a crude. Then, 1.3 L of dimethyl sulfoxide (DMSO) was added to the crude, and the mixture was heated and dissolved. Hot water was added thereto until the mixture became slightly cloudy, and then the mixture was cooled on ice.

After 1 hour, solid-liquid separation was performed by centrifugation. The centrifugation was performed at a temperature of 5° C. and a rotation speed of 3,100 rpm for 15 minutes.

The solid content was washed two times with ethanol, and then dried under reduced pressure at 220° C. overnight to obtain 32.7 g of yellow powder. The yield was 47.1%. Accordingly, BBDCA, which is intermediate, was obtained.

Subsequently, a method for synthesizing the polyphosphoric acid solution of AB-PBI using BBDCA will be described.

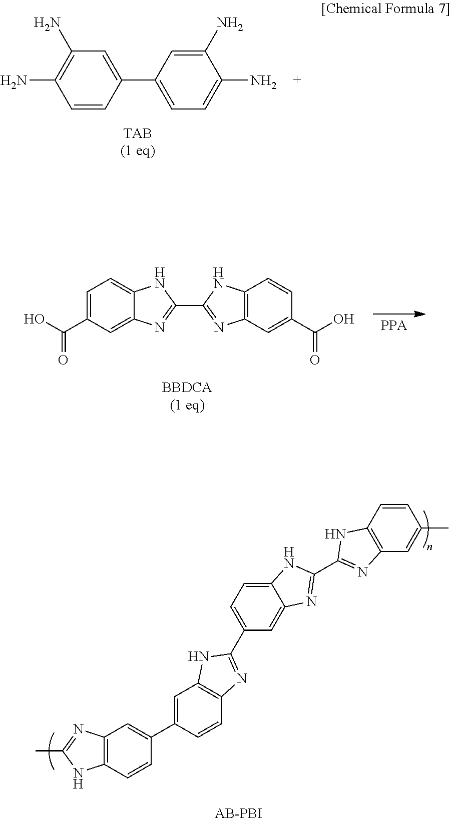

3,3′-diaminobenzidine, BBDCA, and polyphosphoric acid were sequentially added into a 500 ml separable flask. The separable flask containing these materials was immersed in an oil bath preheated to 60° C. and stirred with a mechanical stirrer equipped with a magnetic coupling type stirring seal under an argon gas flow.

The separable flask containing the above-described materials was heated and stirred under a predetermined temperature raising condition, and finally stirred at 220° C. for 20 hours. The temperature of the heating and stirring was raised from 60° C. by 20° C. every 15 minutes, maintained at 140° C. for 2 hours, then raised by 40° C. for 30 minutes, maintained at 180° C. for 10 hours, then raised by 40° C. for 30 minutes, and maintained at 220° C. for 20 hours. After completion of the heating and stirring, the reaction mixture was cooled to 120° C. (bath temperature), and 587.1 g of the polyphosphoric acid solution of AB-PBI was obtained.

In Examples 1 and 2, Nafion 117 was used as protective sheets, and proton conducting membranes were obtained by the press forming. In Examples 3 and 4, poly (vinyl phosphonic acid) was used as protective sheets, and proton conducting membranes were obtained by the press forming. In Examples 5 and 6, Nafion 117 was used as protective sheets, and proton conducting membranes were obtained by the roller forming. In Examples 7 and 8, Nafion 117 was used as protective sheets, and proton conducting membranes were obtained by the press forming. In Example 7, Nafion 117 of Example 1 was reused, and in Example 8, Nafion 117 of Example 2 was reused.

In Comparative Examples 1 and 2, polyethylene terephthalate was used protective sheets, and proton conducting membranes were obtained by the press forming. In Comparative Examples 3 and 4, polybenzimidazole was used as protective sheets, and proton conducting membranes were obtained by the press forming. In Comparative Examples 5 and 6, polyimide was used as protective sheets, and proton conducting membranes were obtained by the press forming. In Comparative Examples 7 and 8, porous polytetrafluoroethylene was used as protective sheets, and proton conducting membranes were obtained by the press forming.

The protective sheets of Comparative Examples 1 to 8 are non-acidic resin films having no acidic substituent. The protective sheets of Comparative Examples 7 and 8 are porous bodies.

In the press forming of each of Examples 1 to 4, 7, and 8 and Comparative Examples 1 to 8, 0.2 grams of the electrolyte resin material was sandwiched between protective sheets, and pressurized at room temperature at a pressure of 10 kN for 60 seconds, at a pressure of 30 kN for 10 seconds, at a pressure of 50 kN for 10 seconds, and at a pressure of 75 kN for 10 seconds. Then, the resultant was left to stand for 1 minute and subjected to hydrolysis to obtain the proton conducting membrane sandwiched between the two protective sheets.

In the roller forming of each of Examples 5 and 6, 0.2 grams of the electrolyte resin material was sandwiched between the protective sheets, and pressure was applied by passing between rollers having a gap of 200 μm twice. Then, the resultant was left to stand for 1 minute and subjected to hydrolysis to obtain the proton conducting membrane sandwiched between the two protective sheets.

For each of the proton conducting membranes obtained in Examples 1 to 8 and Comparative Examples 1 to 8, a peel strength, a membrane thickness, a surface roughness, the amount of phosphoric acid, and a membrane resistance were measured. Various measured values of Examples 1 to 8 and Comparative Examples 1 to 8 are shown in FIG. 6.

A 90 degree peel strength test fixture P90-200 N and a force gauge DRP-50N manufactured by IMADA CO., LTD. were used to measure the 90 degree peel strength at the time of peeling the protective sheet from the proton conducting membrane. The proton conducting membrane sandwiched between the two protective sheets was cut into a rectangle of 20 mm×50 mm and used for measurement of peel strength. One of the protective sheet was fixed to a stainless steel base, and a short side of the other protective sheet was sandwiched by a chuck provided in a force gauge. The protective sheet was linearly pulled in a 90 degree direction at a speed of 10 mm/min, and the force (N) applied for peeling was measured.

In Examples 1 to 8, the peel strengths were 0.13 to 0.53 N, and the protective sheets could be easily peeled off from the proton conducting membranes. It is considered that, in Examples 1 to 8, moisture in air reached the proton conducting membranes through the protective sheets formed of the acidic resin films, and the hydrolysis of the polyphosphoric acid proceeded to reduce the adhesive force. In Examples 1 to 8, the proton conducting membranes having high flatness and high denseness could be obtained.

In Comparative Examples 1 to 6, the peel strengths were 2.47 to 3.87 N, which were significantly larger than those in Examples 1 to 8. It is considered that, in Comparative Examples 1 to 6, moisture in air did not reach the proton conducting membranes via the protective sheets formed of the non-acidic resin films, the hydrolysis of the polyphosphoric acid did not proceed, and the adhesive force did not decrease. In Comparative Examples 1 to 6, when the protective sheets were peeled off, the proton conducting membranes were severely damaged, and proton conducting membranes having high flatness and high denseness could not be obtained.

In Comparative Examples 7 and 8, the peel strengths were 1.58 to 1.87 N, which were larger than those in Examples 1 to 8 and smaller than those in Comparative Examples 1 to 6. It is considered that, in Comparative Examples 7 and 8, moisture in air reached the proton conducting membranes via the protective sheets formed of the porous bodies, and the hydrolysis of the polyphosphoric acid proceeded to slightly decrease the adhesive force. In Comparative Examples 7 and 8, when the protective sheets were peeled off, the proton conducting membranes were severely damaged, and proton conducting membranes having high flatness and high denseness could not be obtained.

The membrane thicknesses of the proton conducting membranes obtained by peeling off the protective sheets were measured. The membrane thicknesses were 7 μm in Example 1, 11 μm in Example 2, 12 μm in Example 3, 18 μm in Example 4, 14 μm in Example 5, 13 μm in Example 6, 111 μm in Example 7, and 138 μm in Example 8. In Examples 1 to 6, the membrane thicknesses were 20 μm or less, and in Examples 7 and 8 in which the protective sheets were reused, the membrane thicknesses were 150 μm or less. In Comparative Examples 1 to 8, the membrane thicknesses could not be measured.

In the measurement of the surface roughness, the root mean square height Sq (μm) was measured in an area range of 2 mm×2 mm in the central portion of the surface of the proton conducting membrane obtained by peeling off the protective sheets using a laser microscope OLS4100 manufactured by Olympus Corporation.

The proton conducting membranes of Examples 1 to 8 had surface roughness of 1.80 to 7.72 μm, and the proton conducting membranes could have high flatness. The proton conducting membranes of Comparative Examples 1 to 8 had surface roughness of 20.15 to 101.99 μm, and the proton conducting membranes could not have high flatness.

The amount of phosphoric acid in each of the proton conducting membranes was measured by neutralization titration using 0.1 M sodium hydroxide. It is known that the amount of phosphoric acid in a proton conducting membrane is inversely proportional to a membrane resistance, and the performance of the proton conducting membrane is correlated with the amount of phosphoric acid present therein.

Each of the proton conducting membranes obtained by peeling off the protective sheets was cut into a rectangle of 20 mm×30 mm, and stirred in 10 mL of pure water for 30 minutes. Two drops of phenolphthalein solution (FUJIFILM Wako Pure Chemical Corporation, Standard content: 1.0 w/v %) as a coloring matter were added thereto, and the mixture was stirred for 5 minutes. A burette was filled with 0.1 M sodium hydroxide, which was added dropwise to perform neutralization titration. After the completion of the titration, the proton conducting membrane was taken out, washed with pure water, dried at 70° C. under vacuum for 3 hours, and then its weight was measured.

The amount x of phosphoric acid in each of the proton conducting membranes was calculated by the following equation. The amount x of phosphoric acid is the number of phosphoric acid molecules per repeating unit of the resin constituting each of the proton conducting membranes.

$$x = \frac{{V}_{N a O H} \times {C}_{N a O H}}{3 \times ( \frac{{W}_{d r y}}{{M}_{w}} )} \qquad [ Equation 1 ]$$

In Equation 1, VNaoH is the volume (I) of sodium hydroxide used for titration, C_{NaOH} is the concentration (mol/l) of sodium hydroxide used for titration, W_{dry} is the mass (g) of the proton conducting membrane after drying, and Mw is the molecular weight (g/mol) of the repeating unit of the polymer of the proton conducting membrane.

The amounts of phosphoric acid in Examples 1 to 8 were 5.50 to 10.85 molecules. In Examples 1 to 8, the proton conducting membranes could contain large amounts of phosphoric acid. In Comparative Examples 1 to 8, the amounts of phosphoric acid could not be measured.

The membrane resistance of each of the proton conducting membranes was measured by cutting each of the proton conducting membranes obtained by peeling off the protective sheets into a 20 mm square sheet and using the sheet as the electrolyte membrane 130 of the fuel cell 100. As the cathode electrode 110 and the anode electrode 120, platinum-supported carbon electrodes having a size of 10 mm square was used. Both sides of the electrolyte membrane 130 were sandwiched between the cathode electrode 110 and the anode electrode 120 and crimped at 0.2 kN to prepare the fuel cell 100.

The fuel cell 100 was subjected to an alternating impedance measurement, and the membrane resistance of the proton conducting membrane was measured. The measurement was performed at 120° C. under a dry nitrogen gas flow without humidification under the conditions of a frequency range of 0.1 Hz to 1 MHz and a voltage amplitude of 10 mV.

The proton conducting membranes of Examples 1 to 8 had membrane resistances of 0.04 to 0.45 Ωμm² and the membrane resistances were low. In Examples 1 to 8, the proton conducting membranes could have excellent proton conductivities.

The membrane resistances of the proton conducting membranes of Comparative Examples 1 to 8 could not be measured. In Comparative Examples 1 to 8, the proton conducting membranes could not have excellent proton conductivities.

In the present embodiment described above, the productivity of the proton conducting membrane can be improved by producing the proton conducting membrane by the pressure forming. Therefore, mass production can be achieved with high yield.

In the present embodiment, the acidic resin films are used as the protective sheets that come into contact with the electrolyte resin material when the electrolyte resin material dissolved in polyphosphoric acid is made into the thin membrane by the pressure forming. Therefore, moisture in air can reach the electrolyte resin material through the protective sheets, the hydrolysis of the polyphosphoric acid can be promoted and the polyphosphoric acid can be phosphorylated, and the protective sheets can be easily peeled off from the proton conducting membrane. Accordingly, even when the proton conducting membrane is manufactured from the electrolyte resin material dissolved in the polyphosphoric acid by the pressure forming, the proton conducting membrane having high flatness and high denseness can be obtained, and the proton conducting membrane having high quality can be obtained.

Furthermore, according to the present embodiment, by manufacturing the proton conducting membrane by the pressure forming, it is possible to easily increase the area of the proton conducting membrane and to reduce the thickness thereof. Accordingly, the proton conducting membrane having a membrane thickness of 150 μm or less can be easily obtained.

Furthermore, in the manufacturing method of the proton conducting membrane of the present embodiment, the hydrolyzing process in which the proton conducting membrane sandwiched between the protective sheets is exposed to air having a predetermined humidity for a predetermined time is provided between the pressing process and the peeling process. Accordingly, the hydrolysis of the polyphosphoric acid can be reliably progressed.

In the manufacturing method of the proton conducting membrane of the present embodiment, the environmental humidity in the hydrolyzing process is set higher than that in the pressing process. As a result, hydrolysis of the polyphosphoric acid can be restricted in the pressing process, the electric field resin material can be thinned as a high-viscosity solution, and hydrolysis of the polyphosphoric acid can be effectively promoted in the hydrolyzing process.

In addition, in the manufacturing method of the proton conducting membrane of the present embodiment, the protective sheets can be easily peeled off from the proton conducting membrane in the peeling process. The peeled protective sheets can be reused as they are for the pressing process of the next proton conducting membrane. Therefore, the productivity of the proton conducting membrane can be improved.

The present disclosure is not limited to the embodiments described above, and various modifications can be made as follows within a range not departing from the spirit of the present disclosure. The means disclosed in each of the above embodiments may be appropriately combined to the extent practicable.

For example, in the above-described embodiment, the two protective sheets 200 and 201 in contact with both surfaces of the electrolyte resin material 202 are the acidic resin films, but it is sufficient that at least the protective sheet in contact with one surface of the electrolyte resin material 202 is the acidic resin film. In this case, a non-acidic resin film can be used as the protective sheet in contact with the other surface of the electrolyte resin material 202. Accordingly, moisture in air can reach the electrolyte resin material 202 through the acidic resin film in contact with the one surface of the electrolyte resin material 202, and the hydrolysis of the polyphosphoric acid can be promoted.

Although the present disclosure has been described in accordance with the embodiments, it is understood that the present disclosure is not limited to the above embodiments or structures. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A manufacturing method of a proton conducting membrane, comprising:
a pressing process of bringing a resin film into contact with at least one surface of an electrolyte resin material dissolved in polyphosphoric acid and applying pressure to form the electrolyte resin material into a membrane shape;
a hydrolyzing process of hydrolyzing and phosphorylating the polyphosphoric acid after the pressing process; and
a peeling process of peeling the resin film from the electrolyte resin material having the membrane shape after the hydrolyzing process to obtain the proton conducting membrane made of the electrolyte resin material containing phosphoric acid, wherein
the resin film is made of a resin having an acidic substituent.

2. The manufacturing method according to claim 1, wherein
the resin constituting the resin film has at least one type of substituent selected from a group consisting of a carboxyl group, a sulfo group, a hydroxy group, a phosphonic group, and derivatives thereof in at least one of a main chain or a side chain.

3. The manufacturing method according to claim 1, wherein
in the hydrolyzing process, an environmental humidity is set to be higher than an environmental humidity in the pressing process.

4. The manufacturing method according to claim 1, wherein
the electrolyte resin material includes a basic resin material having N or NH in a main chain or a side chain, or a resin material having at least one substituent selected from a group consisting of a sulfo group, a carboxyl group, a hydroxy group, a phosphonic group, and derivatives thereof in at least one of a main chain or a side chain.

5. The manufacturing method according to claim 4, wherein
the electrolyte resin material includes at least one selected from a group consisting of polybenzimidazole, sulfonated polyimide, perfluorosulfonic acid polymer, and derivatives thereof.

6. The manufacturing method according to claim 1, wherein
the resin film peeled off in the peeling process is reused in the pressing process for manufacturing a next proton conducting membrane.

7. The manufacturing method according to claim 1, wherein
a concentration of the electrolyte resin material dissolved in the polyphosphoric acid is in a range from 1 wt % to 20 wt %. less.

8. The manufacturing method according to claim 1, wherein
the proton conducting membrane is formed to have a thickness of 150 μm or less.
